(19) United States
(12) Patent Application Publication
(10) Pub. No.: US 2014/0168434 A1
(43) Pub. Date: Jun. 19, 2014

(54) DUAL-Q IMAGING SYSTEM

(71) Applicant: DIGITALGLOBE, INC., Longmont, CO (US)

(72) Inventor: Frank Gerlach, Longmont, CO (US)

(73) Assignee: DIGITALGLOBE, INC., Longmont, CO (US)

(21) Appl. No.: 13/715,483

(22) Filed: Dec. 14, 2012

(51) Int. Cl. H04N 7/18

(52) U.S. Cl. CPC H04N 7/183
USPC 348/144

(57) ABSTRACT

A optical system carried by a flying object such as a satellite or aircraft having a pair of optical paths having different Q values for obtaining a pair of images of the same spot on the Earth's (or other celestial body's) surface. The optical paths may have a portion in common with each other and a portion not in common with each other. Light is directed into the optical paths via a field sharing arrangement. One of the optical paths together with an imaging device creates relatively narrower field of view images with a higher ground resolution than the other optical path together with an imaging device.

### BACKGROUND

High resolution images of selected portions of the Earth's surface have become a product desired and used by government agencies, corporations, and individuals. Many consumer products in common use today include such images, such as Google Earth. Many different types of image collection platforms may be employed, including aircraft and earth-orbiting satellites.

For satellite-based imaging, linear array CCD devices are typically used. In consumer digital cameras, the various image sensors are arranged in an area array (e.g., 3,000 rows of 3,000 pixels each, or 9,000,000 total pixels) which collects the image area in a single “snapshot.” A line or linear array imaging device, on the other hand, may include a relatively small number of rows of a great number of pixels in each row. For example, for Earth imaging applications, there may be individual rows of 50,000 pixels each. Each row of pixels is scanned across the earth to build an image line by line. The width of the image is the product of the number of pixels in the row times the pixel size or resolution; for example, 50,000 pixels at 0.5 meter ground resolution produces an image that is 25,000 meters (25 kilometers) wide. The length of the image is controlled by the scan duration (i.e. number of lines), which is typically settable for each image collected. Although the examples cited herein focus on satellite-based linear arrays, the techniques taught herein can be readily applied to other remote sensing systems, such as aerial cameras or area arrays.

In obtaining these Earth images, there may be diametrically opposed requirements. For example, it may be desirable to obtain both large area coverage at lower resolution as well as small area coverage at high resolution. For a single instrument with a fixed focal plane (linear imaging array) length, as the ground resolution is increased, the width of the image (field of view) decreases proportionally and hence the area coverage decreases as well. Following the example from above, if the ground resolution increases from 0.5 to 0.25 meters, the image width (field of view) reduces from 25 to 12.5 kilometers. Also, at a given line scan rate (lines per second), it takes twice as long to scan across the same length of ground, further reducing area coverage efficiency. The converse is also true. If these differences in requirements for large area coverage and high resolution become too diverse, it may not be achievable with a single instrument or a single satellite.

What is needed, therefore, is a technique to allow for both lower and higher resolution images to be obtained. It is against this background that the techniques disclosed herein have been developed.

### SUMMARY

Disclosed herein is an optical system for use in an object above a celestial body in combination with an imaging device also in the object, the system and the device being used to obtain images of portions of the surface of the celestial body. The system includes a first optical path having a plurality of optical elements therein, the first optical path have a first focal length and a second optical path having a plurality of optical elements therein, the second optical path have a second focal length that is different from the first focal length. Light entering the optical system is directed into one of the first and second optical paths based on a shared field arrangement.

The shared field arrangement may include a pair of mirrors, one in the first optical path and one in the second optical path, that direct the light in the optical system into one of the first and second optical paths, or alternatively refractive components could be used. The pair of mirrors may each reflect light of the entire visible spectrum. The imaging devices associated with the two optical paths may be operated at different times with only the imaging device associated with the first optical path operating during certain times and only the second imaging device associated with the second optical path operating during certain other times.

The imaging device may capture images from the light directed thereto by the first and second optical paths, the images from the two optical paths being captured simultaneously. The pair of simultaneous images may be taken with a central point in each image being offset from each other on the Earth's surface, with one image having a relatively narrow field of view and relatively higher ground resolution and the other image having a relatively wider field of view and relatively lower ground resolution.

The two different focal lengths may be different by a factor of approximately two, and may be different by a factor in the range from 1.4 to 2. A portion of the optical elements of the first optical path may be in the second optical path and the remainder of the optical elements of the first optical path may not be in the second optical path.

Also disclosed is an optical system for use in an object above a celestial body in combination with a pair of imaging devices also in the object, the system and the device being used to obtain images of portions of the surface of the celestial body. The system includes a first imaging system including a first optical path and a first imaging device, the first imaging system having a Q value of Q1, and a second imaging system including a second optical path and a second imaging device, the second imaging system having a Q value of Q2, wherein Q2 is different than Q1. Q=(λ*focal length)/aperture diameter/pixel size, where A is a specified wavelength of light obtained by the optical system, and pixel size is the size of the pixels in the imaging device.

The light coming into the system may be directed into one of the first and second optical paths via a field sharing arrangement. The first and second imaging device may be substantially identical. The first and second imaging device may be operated at different times with only the first imaging device operating during certain times and only the second imaging device operating during certain other times. The first and second imaging device may be operated simultaneously to each obtain a series of images. The images from the first and second imaging device may be taken at substantially the same instant in time and are taken with a central point in each image being offset from each other on the celestial body's surface, with one image having a relatively narrow field of view and relatively higher ground resolution and the other image having a relatively wider field of view and relatively lower ground resolution.

The values of Q1 and Q2 may be different by a factor of approximately two, and may be different by a factor in the range from 1.4 to 2.

Also disclosed is an optical system for use in an object above a celestial body in combination with an imaging device also in the object, the system and the device being used to obtain images of portions of the surface of the celestial body. The system includes an optical telescope that receives light from the outer surface of the celestial body and forms a focused image at an image plane; a first optical path that includes at least a relay mirror and an image sensor, the relay mirror being located on an opposite side of the image plane from the optical telescope to receive light diverging from the focused image at the image plane; and a second optical path that includes at least a relay mirror and an image sensor, the relay mirror being located on an opposite side of the image plane from the optical telescope to receive light diverging from the focused image at the image plane, the second optical path being different from the first optical path, and the second optical path producing an image of the outer surface of the celestial body that has a relatively narrower field of view than the first optical path and a relatively higher ground resolution than the first optical path. The relay mirror of the first optical path and the relay mirror of the second optical path are positioned so as to receive light from two different portions of the focused image.

The optical telescope may be a reflecting telescope. The reflecting telescope may be a Cassegrain telescope having a primary mirror and a secondary mirror, the primary mirror having an opening defined at a center thereof. The image plane may be located on an opposite side of the opening from the secondary mirror. The optical paths may have Q values that are different by a factor in the range of approximately two, and may be different by a factor from 1.4 to 2.

### BRIEF DESCRIPTION OF THE DRAWINGS

The disclosure herein is described with reference to the following drawings, wherein like reference numbers denote substantially similar elements:

FIG. 1 is a depiction of a satellite orbiting the Earth and carrying an optical imaging system for obtaining images of selected portions of the Earth's surface.

FIG. 2 is a block diagram of a potential system/scenario including the satellite of FIG. 1, in which images taken thereby may be accessible to a user.

FIG. 3 is a depiction of the satellite of FIG. 1 receiving sunlight reflected from the Earth.

FIG. 4 is a depiction of certain relevant portions of the optical imaging system carried by the satellite of FIG. 1.

FIGS. 5a and 5b are depictions that show an image produced by an optical telescope of the imaging system and the areas in each image that are at that moment being captured by a pair of image sensing line arrays.

FIGS. 6a and 6b are depictions of the relative sizes of areas (fields of view, based on the same size imaging array) in an urban region imaged by the low-Q and high-Q imaging systems, respectively.

FIGS. 7a and 7b are depictions of images that can be created by piecing together a series of image lines produced by the low-Q and high-Q imaging systems, respectively.

### DETAILED DESCRIPTION

While the embodiments disclosed herein are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims. The disclosure is described with reference to the drawings, wherein like reference numbers denote substantially similar elements.

Definitions

As used herein, a “telescope” is an optical instrument that aids in the observation or imaging of remote objects by collecting electromagnetic radiation (such as visible light).

An “image capturing device” records the image created by the telescope and converts photons to electrons and subsequently to digitized numbers that are reconstructed into a picture. Two example of image capturing devices are CCD image sensors and CMOS image sensors.

An “optical imaging system” includes at least a telescope and an image capturing device.

“Resolution” is the size of each pixel in an image as measured on the ground. Thus, higher resolution means a smaller ground area covered by a given pixel.

“Signal-to-Noise ratio (SNR)” is a measure of the amount of desired signal from each pixel divided by the amount of noise signal from each pixel.

“F-number (Fn)” is the focal length of the optical imaging system divided by its aperture diameter.

The “Q” of an optical imaging system is defined as the ratio of the F-number of the optical imaging system divided by the focal plane detector size, Dp, at a specified wavelength, λ, or Q=λ*Fn/Dp. Q is a measure of whether the system's image quality will be limited by the optics F-number (which is akin to being limited by the aperture size) or by the detector size.

The “cutoff frequency of the optics” is defined by:

Ko_optics=1000/λ*Fn (units of cycles/millimeter)

The “detector cutoff frequency” is defined by:

Ko_detector=1000/Dp (units of cycles/millimeter)

For a system with a Q=1, the detector cutoff would equal the optics cutoff. As Q increases, the optics Fn (effectively, aperture size for a given focal length) becomes the limiting parameter on image quality. Conversely, as Q decreases, the detector size becomes the limiting parameter on image quality.

“Ground Sampled Distance” means the distance on the ground sampled by a single pixel in a particular instant in time (measured along one side of the generally square shape of the area sampled by a single pixel).

“Ground Swath Width” means the width of the area on the ground imaged at a particular instant in time by the linear array of the image sensor (measured along a line passing through the entire row of pixels).

The “Field of View (FOV)” is the angular subtense of the ground covered by the imaging array as seen from the instrument.

Satellite Imaging Applications

As Q increases above one, the imagery becomes more blurry and the SNR also decreases as the square root of Q. However, the increased resolution of the imagery can often more than offset these two degrading parameters if the SNR is kept high enough and the line-of-sight stability of the satellite/telescope is maintained at a sufficient level.

Conversely, as the Q decreases below one, the resolution of the imagery decreases, while the SNR increases, and the imagery becomes sharper. However, an artifact known as aliasing can occur with lower Q values, where long straight lines for example become hashed.

Given these effects, it becomes desirable to have a higher Q system for higher resolution small area or point targets. These targets, since they are small, can be scanned slower, hence exposed longer, to overcome the loss in SNR, if required, without an appreciable loss in collection efficiency.

Conversely, a lower Q system is more amenable to lower resolution large area imaging requirements, since the inherent higher SNR allows for faster scanning and hence better area collection efficiency without a loss in image quality.

If the requirements for resolution and area coverage are too far apart, they may not be achievable or one may be achieved with a corresponding shortfall in the other requirement. A system with two different optical paths having different Q values (a Dual Q system) may overcome this shortfall. While certain examples and references herein discuss two optical paths (dual-Q) these teachings are equally applicable to three or more optical paths of different Q values.

In this class of high resolution satellite imaging systems, minimizing the light loss due to transmission losses in the optics, and hence maximizing the signal arriving at the focal plane, is critical. For a system where any given spectral band is collected with only a single Q value, this may be achieved with dichroic beam splitters, for example, with minimal loss of signal. However, when the light in a spectral band is split into two or more optical paths with different Q values, the loss in transmission due to beam splitting would be at least 50 percent, an unacceptable loss.

The dual Q system concept utilizes a common front end (or fore) optic. The use of linear CCD arrays allows for the dimension in the scanning direction to be narrow enough that the field of view can be shared in the scan direction. This field sharing approach results in high transmission for both Q systems. The Q for each instrument is independently achieved by separate powered relay optics in the aft end of the optical system, or aft optics. The optical magnifications of the separate relays provide both the different effective focal lengths, hence different Qs, as well as being an integral part of providing a diffraction limited wavefront at the focal plane. These relays may be either reflective, refractive, or catadioptric. Fold mirrors, as required, are used for optimum packaging and do not contribute to the Q.

The instantaneous field of view, IFOV, of each Q system is the detector size divided by the corresponding focal length. Thus, with different focal lengths (and thus different Q values) for each system, different resolutions (and thus different image widths) can be provided. By matching the line scan rate of each focal plane relative to its IFOV (or resolution), simultaneous imaging of both instruments can be achieved.

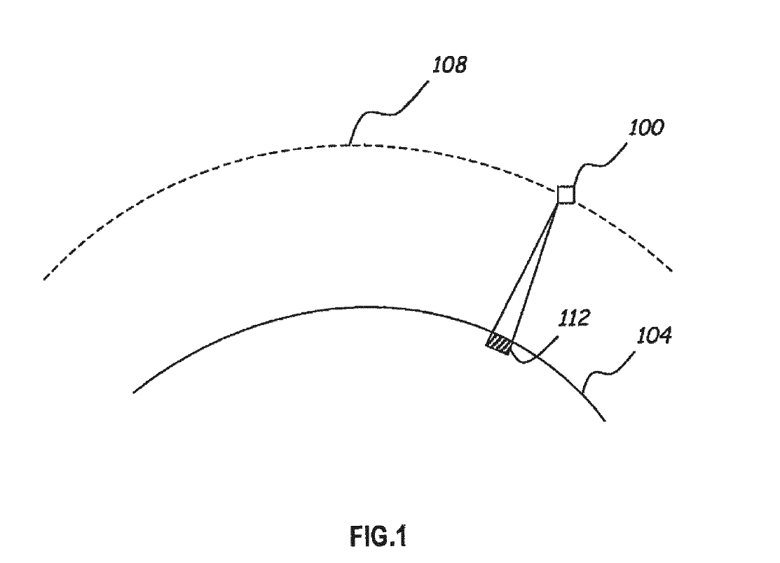

Referring to FIG. 1, an illustration of a satellite 100 orbiting a planet 104 is described. At the outset, it is noted that, when referring to the earth herein, reference is made to any celestial body of which it may be desirable to acquire images or other remote sensing information. Furthermore, when referring to a satellite herein, reference is made to any spacecraft, satellite, and/or aircraft capable of acquiring images or other remote sensing information. Furthermore, the system described herein may also be applied to other imaging systems, including imaging systems located on the earth or in space that acquire images of other celestial bodies. It is also noted that none of the drawing figures contained herein are drawn to scale, and that such figures are for the purposes of discussion and illustration only.

As illustrated in FIG. 1, the satellite 100 may orbit the earth 104 following an orbital path 108. An imaging system aboard the satellite 100 may be capable of acquiring an image of an area 112 that includes a portion of the surface of the earth 104. The image of the area 112 may include a plurality of pixels of image data. Furthermore, the satellite 100 may collect images of areas 112 in either or both of gray scale or in a number of spectral bands. Data may be collected and processed, and images may be produced therefrom. The data may include digital numbers (DNs), for example, on an 8-bit or 11-bit radiometric brightness scale. The DNs may be processed to generate an image that is useful for the application required by a user. Images collected from the satellite 100 may be used in a number of applications, including both commercial and non-commercial applications.

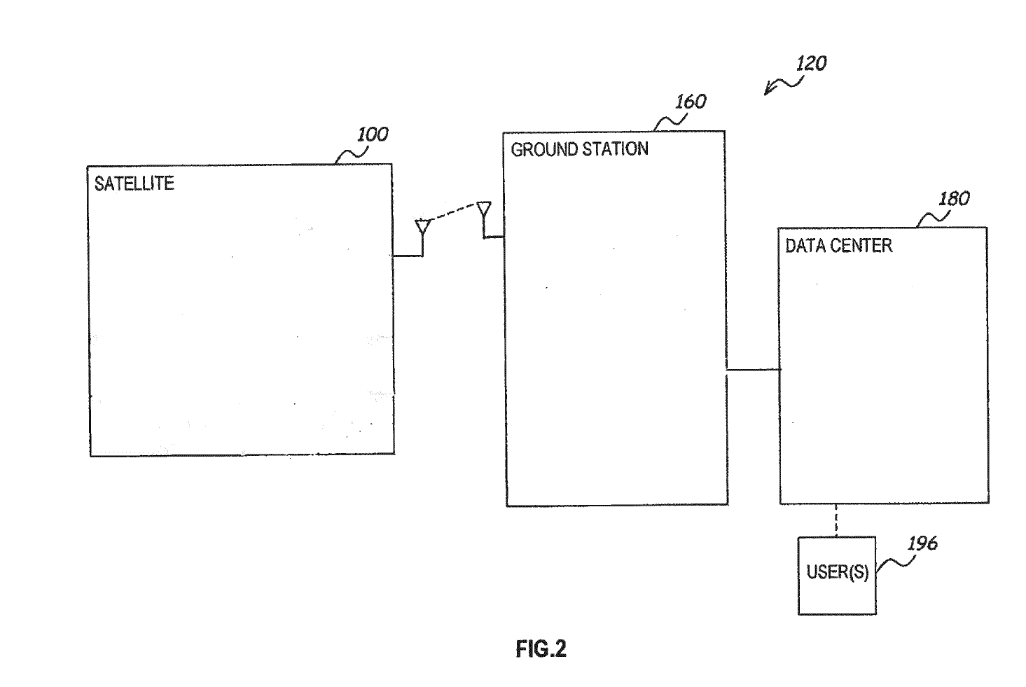

FIG. 2 includes a block diagram representation of an image collection and distribution system 120. In this embodiment, the satellite 100 may include a number of systems, including power/positioning systems, a transmit/receive system, and an imaging system. Other systems may also be included, but are omitted for ease of explanation. Such a satellite and associated systems are well known in the art, and therefore are not described in detail herein as it is sufficient to say that the satellite 100 may receive power and may be positioned to collect desired images and transmit/receive data to/from a ground location and/or other satellite systems. The imaging system may include charge coupled device (CCD) arrays and associated optics to collect electromagnetic energy and focus the energy at the CCD arrays. The CCD arrays may also include electronics to sample the CCD arrays and output a digital number (DN) that is proportional to the amount of energy collected at the CCD array. Each CCD array includes a number of pixels, and the imaging system may operate as a pushbroom or whiskbroom imaging system. Thus, a plurality of DNs for each pixel may be output from the imaging system.

The satellite 100 may transmit and receive data to and from a ground station 160. The ground station 160 of this embodiment may include a transmit/receive system, a data storage system, a control system, and a communication system. In one embodiment, a number of ground stations 160 may exist and be able to communicate with the satellite 100 throughout different portions of the satellite 100 orbit. The transmit/receive system may be used to send and receive data to and from the satellite 100. The data storage system may be used to store image data collected by the imaging system and sent from the satellite 100 to the ground station 160. The control system, in one embodiment, may be used for satellite control and may transmit/receive control information through the transmit/receive system to/from the satellite. The communication system may be used for communications between the ground station 160 and one or more data centers 180. The data center 180 may include a communication system, a data storage system, and an image processing system. The image processing system may process the data from the imaging system and provide a digital image to one or more user(s) 196. Alternatively, the image data received from the satellite 100 at the ground station 160 may be sent from the ground station 160 to a user 196 directly. The image data may be processed by the user using one or more techniques described herein to accommodate the user's needs.

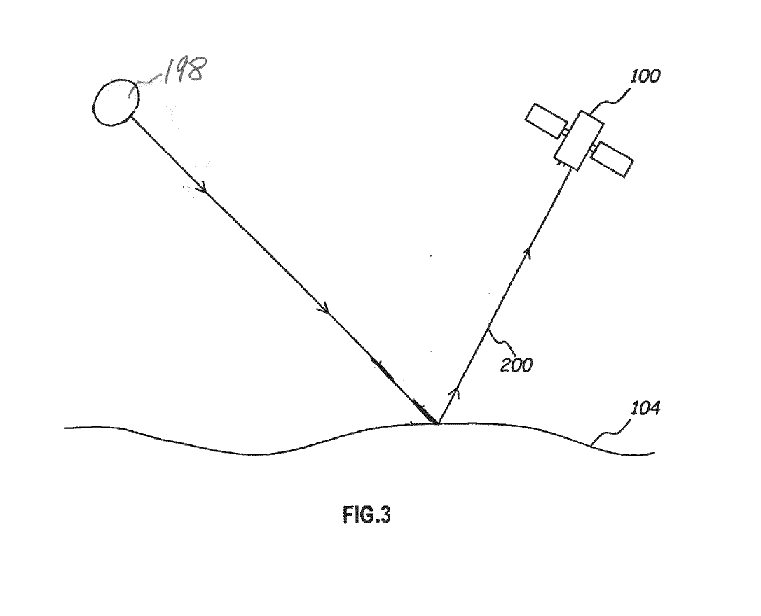

Referring now to FIG. 3, an illustration of an imaging system collecting sensing data is now described. The satellite 100, as illustrated in FIG. 3, receives light that has been radiated from the sun 198 and reflected from the earth 104, shown in FIG. 3 as light ray 200.

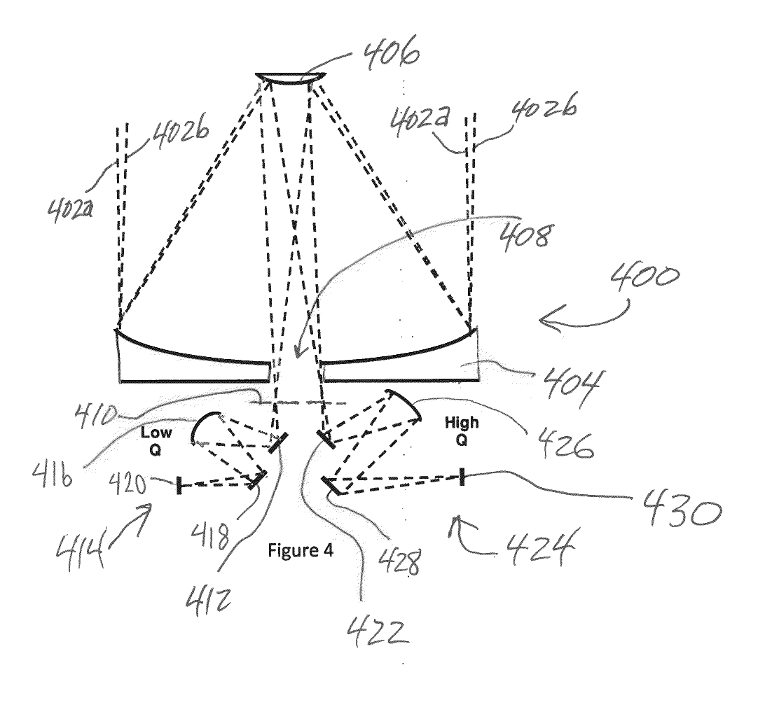

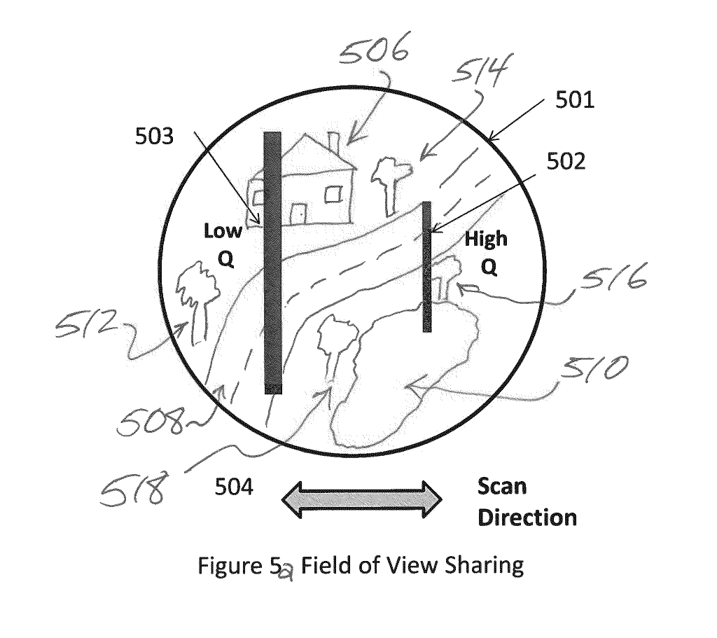

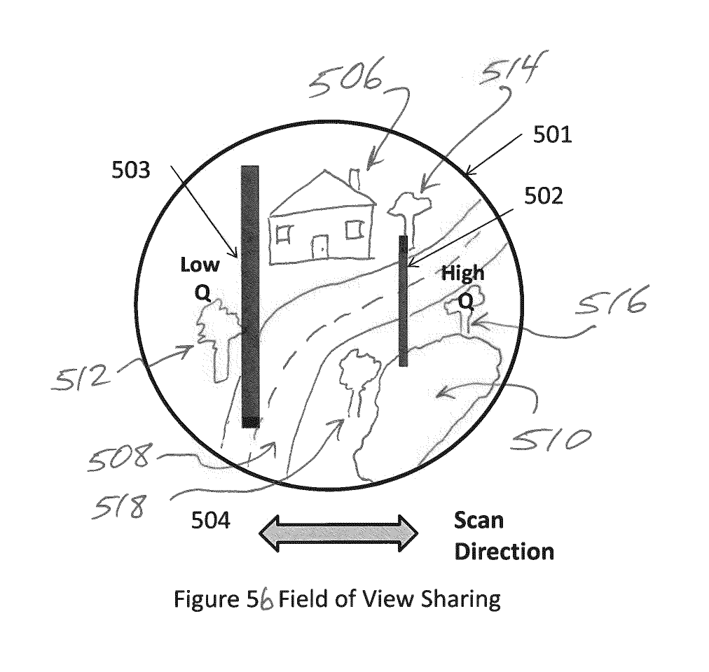

FIG. 4 shows at least a portion of the imaging system in the satellite, including an optical telescope 400. Incoming light 402a and 402b may be reflected by a primary mirror 404 off and directed toward a secondary mirror 406 where the light is re-directed through an opening 408 defined along a central axis of the primary mirror 404. It can be appreciated that a focused image would exist at an image plane 410 if there were a surface there for the image to appear on. Since there is no such surface, the light (after passing through the image plane 410) is then reflected by the first fold mirror 412 of the first optical path 414 or the first fold mirror 422 of the second optical path 424. The light is split into the first and second optical paths 414 and 424 via a field sharing arrangement. Field sharing is discussed in further detail with respect to FIGS. 5a and 5b. As one example, the primary mirror 404 may have a diameter in the range of 1 to 1.5 meters, although other suitable sizes could also be used. The telescope 400 shown in this example is of the Cassegrain type, although other types of telescope could be employed.

FIG. 5a shows a simplified example of an image 501 that might appear at the image plane 410 of FIG. 4. As can be seen, the image 501 includes a house 506, a road 508, a small pond 510, and four trees 512, 514, 516, and 518. It can be seen that the locations of the first fold mirror 412 of the first optical path 414 and the first fold mirror 422 of the second optical path 424, just below the image plane 410 in FIG. 4, yet spaced apart from each other (horizontally in the view of FIG. 4), result in the first optical path 414 imaging one area 503 in the image 501 while the second optical path 424 images a different area 502 in the image. Further, it can be seen in FIG. 5a that the area 502 being imaged by the high-Q optical path 424 includes portions of the road 508, the pond 510, and the tree 516. Similarly, the area 503 being imaged by the low-Q optical path 414 includes portions of the road 508 and the house 506. Because the satellite 100 is moving relative to the ground 104, scanning takes place. The rate of capturing an image of the area 503 and passing the image data to associated electronics, together with the rate of movement of the satellite 100 relative to the ground 104, can be controlled to allow for a subsequent image to be captured of an area immediately adjacent to the area 503. As this is repeated continuously for each of the two optical systems, it can be appreciated that an entire image of the region can be obtained in either or both of the two optical systems.

FIG. 5b shows a subsequent image 501 focused by the optical telescope and the specific areas 502 and 503 being imaged by the two different optical paths. As can be seen, now the area 502 covers a different portion of the pond 510, a different portion of the road 508, a portion of the tree 514, and does not cover any portion of the tree 516. Similarly, the area 503 covers a different portion of the road 508, a portion of the tree 512, and does not cover any portion of the house 506. Note that the amount by which the objects on the ground have shifted in the image 501 is more than the width of the area 503 being scanned. Instead of showing the next adjacent area being imaged, so as to be easiest for the reader to appreciate the movement, a greater shift was illustrated. Of course, in order to generate a continuous image, it would be desirable to next capture an image of the area immediately to the right of the area 503.

It can be appreciated that at any given instant in time, the two optical systems are imaging two slightly different areas on the ground 104. The two different areas are near, but spaced apart from, each other. But because the time from scanning one area to an area just adjacent is on the order of fractions of a second, one optical system will obtain an image of the same area already imaged by the other optical system a matter of tens or at most hundreds of milliseconds later, depending on the line rate of the linear array. Thus, the two optical systems are essentially imaging the same area at nearly the same point in time.

Thus, in summary, field sharing as used in this patent application refers to a system that creates a two-dimensional image at an image plane (or multiple image planes), different points of which can be simultaneously captured by different optical systems at different magnifications or optical Q values within the same overlapping spectral bandpasses. Accordingly, in such an arrangement, all of the light from a first group of particular points in the image may be captured by one of the optical systems and all of the light from a second group of particular points in the image may be captured by another of the optical systems. Thus, there is no splitting of the light from a particular point in the image into different paths. In such light-splitting systems, the total light in each optical path is decreased due to the light-splitting, which may be undesirable.

In the disclosed embodiment, referring back to FIG. 4, the first optical path 414 may also include second and third fold mirrors 416 and 418 and image sensor 420. The second optical path 424 may also include second and third fold mirrors 426 and 428 and image sensor 430. As can be seen in FIG. 4, the length of the second optical path 424 is greater than the length of the first optical path 414. In this case, that difference in length is due to the greater magnification of the relay optical system and results in the focal length of the second optical path 424 being greater than the focal length of the first optical path 414. Since the Q of the optical path is proportional to the focal length, this means that the Q of the second optical path 424 is greater than the Q of the first optical path 414. This also means that the second optical path 424 produces an image with a smaller FOV (narrower width) and a higher ground resolution (smaller pixel size) than the image produced by the first optical path 414, given that the linear array image sensors' lengths are the same.

In one embodiment, the image sensor 420 and the image sensor 430 are substantially identical. In such case, they each have the same size pixels, the same spacing between pixels, and the same array of pixels. For example, there may be one or more rows of 50,000 pixels each. Alternatively, different types of image sensors could be used. For the same common aperture optical path, different size image sensor detectors result in different values of Q.

Further, in at least one embodiment, the two optical systems (formed by the two optical paths 414 and 424 and image sensors 420 and 430 together with the primary and secondary mirrors 404 and 406) are optically aligned relative to each other in a fashion so as to be directed to two closely-proximate, but not identical, areas on the Earth's surface. In addition, since one has a smaller FOV (narrower width) than the other, they do not cover the exact same width and hence size area.

If scanning is occurring simultaneously for the low-Q and high-Q optical paths, because the two optical paths cover differently-sized GSDs (different resolutions), it may be necessary for the line rate for the high-Q system to be greater than for the low-Q system, since each consecutive line (area) imaged by the high-Q system is only half the size of each line (area) imaged by the low-Q system. Thus, the line rate for the high-Q system may be twice as high as the line rate for the low-Q system.

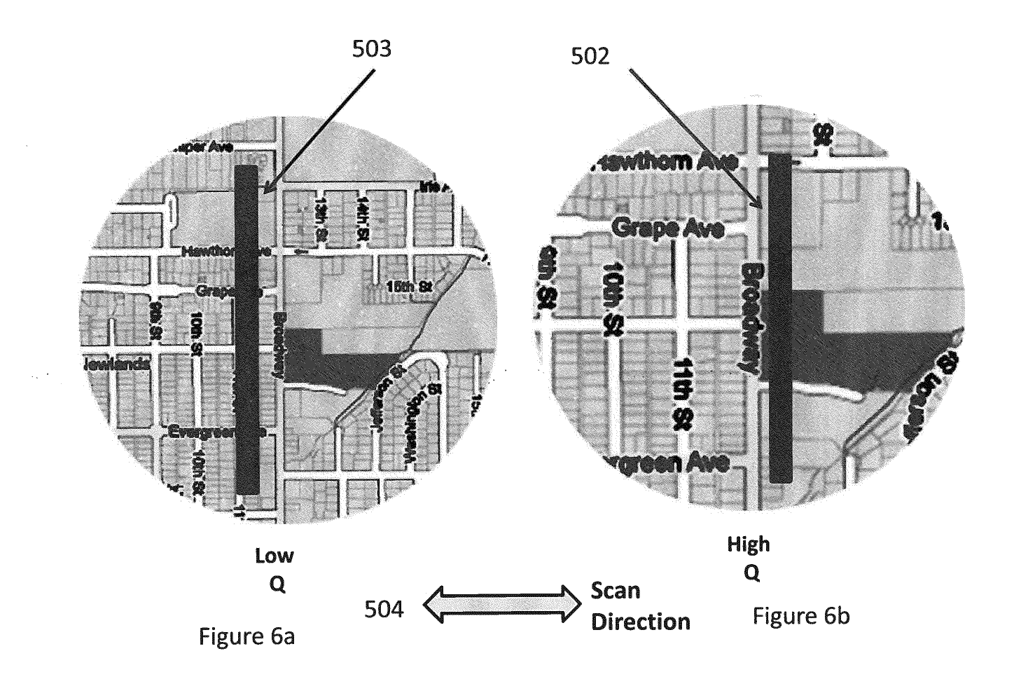

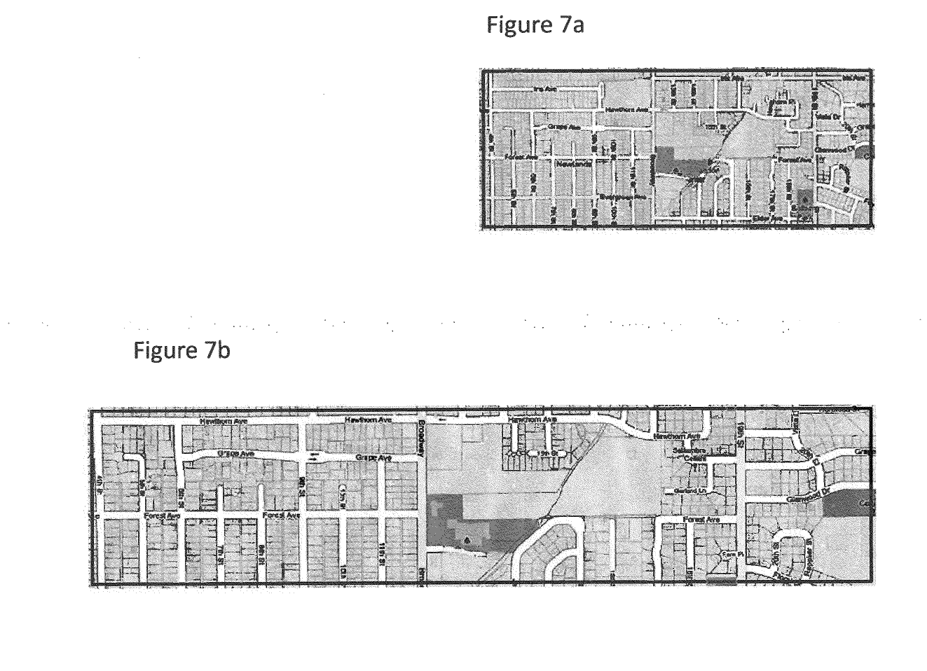

Another way of illustrating the low-Q and the high-Q imaging systems is provided in FIGS. 6a, 6b, 7a, and 7b. FIG. 6a depicts the scale or level of magnification of the low-Q sensor (which might cover the area 503 shown), while FIG. 6b depicts the scale or level of magnification of the high-Q sensor (which might cover the area 502 shown). As can be appreciated, the area 503 covers roughly twice the area in an urban region on the Earth as does the area 502. FIG. 7a shows an image that could be generated by piecing together a series of images 503, while FIG. 7b shows an image that could be generated by piecing together a series of images 502.

As one example of the two different Q values for the two different optical paths, the following detailed example is provided. The altitude of the satellite above the earth may be 680 km and the average wavelength may be 675 nm. A first optical path may have a Q of 0.80, based on an Aperture Diameter of 70 cm, a Focal Length of 10 m, a Panchromatic Line Rate of 6500 lines/sec, with 13,500 Panchromatic Detectors, and a Panchromatic Detector Size of 12 um. Such an optical path would capture images with a Ground Sampled Distance (resolution) of 81 cm and an Ground Swath Width (image width) of 11 km.

It may be desirable for the second optical path to have a Q that is in the range of twice that of the first optical path. Thus, the second optical path may have a Q of 1.6. Assuming the same imaging sensor, the characteristics of the second optical path would be: Focal Length of 20 m, Ground Sampled Distance (resolution) of 40.5 cm and a Ground Swath Width (image width) of 5.5 km. In this example, the Q of the second optical path is twice that of the Q of the first path. While it may be desirable for one Q value to be approximately twice the other Q value, it may also be desirable for one Q value to be anywhere in the range of 1.4 times to 2.2 times the other Q value or any other desired relationship between the two Q values. In cases where it is desirable to operate the two optical paths simultaneously to obtain images of different magnifications, the Panchromatic Line Rate for the second optical path could be 13,000 lines/sec so as to cover a similar sized ground area per unit of time as the first optical path.

Even with the same Panchromatic Line Rate, the SNR of the second optical path, given the same exposure parameters would decrease by the ratio of the square root of the Qs. Thus, the SNR of the high-Q system would therefore be 71 percent that of the low-Q optical path. However, because of the faster Panchromatic Line Rate for the second optical (high-Q) path, the SNR will be decreased even further.

At times in this patent application, the term optical path may refer only to two or more relay mirrors, while at other times the term optical path may refer to the combination of an image sensor with two or more relay mirrors, while at other times the term optical path may refer to the combination of an optical telescope with two or more relay mirrors, while at other times the term optical path may refer to the combination of an optical telescope, an image sensor, and two or more relay mirrors.

The embodiments specifically described in this patent application include two different optical path/image sensor combinations to create two different images. It is to be specifically understood that it is within the scope of the inventions disclosed and claimed herein that these two different images could be captured simultaneously or at different times. Further, the system may at any given time select between capturing both images simultaneously, capturing images only with the high-Q optical path, capturing images only with the low-Q optical path, alternating the capture of images between the two different optical paths, or any other combination thereof. Further, the satellite could transmit a single data stream with the images captured from each optical path or transmit more than one data stream with each data stream containing images from a different optical path. As previously mentioned, the data streams could be recorded at any point downstream thereof.

Similarly, while the descriptions herein discuss only two different optical paths and images, any other number of optical paths could be included, given what the volume for packaging and the optical quality over the full field of view allow, to produce any number of images with different characteristics. For example, there could be three different optical paths, with three different Q values. Further, there need not be a one-to-one correspondence between the number of optical paths and the number of types of images produced. One example of a way in which more types of images could be produced than the number of optical paths would be if one or more of the optical paths included an electro-optical or other type of component that could be controlled to change the characteristics or position of the light downstream of that component so as to change the characteristics of the image obtained via that optical path. Another example would be if the image sensor could be controlled to change the characteristics of the image obtained thereby. One fashion in which this might be accomplished would be for the pixels of the image sensor to be controlled to combine four different pixels (such as in a 2×2 sub-array) to combine their signals to act as one pixel.

Still another example would be to use an area array (staring array or any generally rectangular array with a significant number of pixels in each orthogonal direction in the array). One way in which this could be implemented would be for two different optical paths to focus light on two different portions of the same area array. For example, one portion of the area array could be used to image the light from high-Q optical path and another portion of the area array could be used to image the light from the low-Q optical path. As an alternative, separate area arrays could be used for the two optical paths, or an area array could be used with one optical path and a linear array could be used with the other optical path.

Further, there are a variety of ways of changing the Q of an optical path. This can include changing the focal length, changing the wavelength of the light passing therethrough, changing the aperture size, changing the pixel size, and potentially by other means. It should be understood that the inventions disclosed and claimed herein include such other means for varying the Q.

Also, each of the first and second optical paths disclosed herein include three fold or relay mirrors. Similar systems could be designed that include more or less fold mirrors, that include fold mirrors oriented in different ways, or that include additional or different components than fold mirrors (e.g., refractive optical components such as lenses). For example, there could be only one relay mirror in each optical path, or two mirrors, of four or more mirrors. Thus, the inventions disclosed and claimed herein include other types of optical path arrangements.

As can be appreciated the systems disclosed herein have the advantage that they provide the option to have two different Q values and thus two different levels of magnification or ground resolution (ground sampled distance). Further, this is achieved without any mechanical, moving parts in the optical paths, without splitting the light based on the wavelength thereof (thus decreasing the light level in the image), and without any type of light-splitting. Further, one moving parts implementation might utilize a zoom lens, which typically decreases the image quality as compared to a fixed focal length.

The embodiments disclosed herein have involved imaging portions of the Earth's surface. It should be understood that the inventions herein apply equally to imaging the surface of any celestial body. Further, the embodiments disclosed herein have involved optical systems carried by a satellite. It should be understood that the inventions herein apply equally to optical systems carried by any object or vehicle positioned, flying, orbiting, or in any other fashion located above the surface of any other object. An aircraft is but one example of such a vehicle.

While the embodiments of the invention have been illustrated and described in detail in the drawings and foregoing description, such illustration and description are to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

I CLAIM:

A1. An optical system for use in an object above a celestial body in combination with an imaging device also in the object, the system and the device being used to obtain images of portions of the surface of the celestial body, the system comprising:
a first optical path having a plurality of optical elements therein, the first optical path have a first focal length; and
a second optical path having a plurality of optical elements therein, the second optical path have a second focal length that is different from the first focal length;
wherein light entering the optical system is directed into one of the first and second optical paths based on a shared field arrangement.

2. An optical system as defined in claim 1, wherein the shared field arrangement includes a pair of mirrors, one in the first optical path and one in the second optical path, that direct the light in the optical system into one of the first and second optical paths.

3. An optical system as defined in claim 1, wherein the pair of mirrors each reflect light of the entire visible spectrum.

4. An optical system as defined in claim 1, wherein the imaging devices associated with the two optical paths are operated at different times with only the imaging device associated with the first optical path operating during certain times and only the second imaging device associated with the second optical path operating during certain other times.

5. An optical system as defined in claim 1, wherein the imaging device captures images from the light directed thereto by the first and second optical paths, the images from the two optical paths being captured simultaneously.

6. An optical system as defined in claim 5, wherein the pair of simultaneous images are taken with a central point in each image being offset from each other on the Earth's surface, with one image having a relatively narrow field of view and relatively higher ground resolution and the other image having a relatively wider field of view and relatively lower ground resolution.

7. An optical system as defined in claim 1, wherein the two different focal lengths are different by a factor of approximately two.

8. An optical system as defined in claim 1, wherein the two different focal lengths are different by a factor in the range from 1.4 to 2.

9. An optical system as defined in claim 1, wherein a portion of the optical elements of the first optical path are in the second optical path and the remainder of the optical elements of the first optical path are not in the second optical path.

10. An optical system for use in an object above a celestial body in combination with a pair of imaging devices also in the object, the system and the device being used to obtain images of portions of the surface of the celestial body, the system comprising:
a first imaging system including a first optical path and a first imaging device, the first imaging system having a Q value of Q₁; and
a second imaging system including a second optical path and a second imaging device, the second imaging system having a Q value of Q₂, wherein Q₂ is different than Q₁;
where Q=(A*focal length)/ aperture diameter/pixel size, where A is a specified wavelength of light obtained by the optical system, and pixel size is the size of the pixels in the imaging device.

11. An optical system as defined in claim 10, wherein the light coming into the system is directed into one of the first and second optical paths via a field sharing arrangement.

12. An optical system as defined in claim 10, wherein the first and second imaging device are substantially identical.

13. An optical system as defined in claim 10, wherein the first and second imaging device are operated at different times with only the first imaging device operating during certain times and only the second imaging device operating during certain other times.

14. An optical system as defined in claim 10, wherein the first and second imaging device are operated simultaneously to each obtain a series of images.

15. An optical system as defined in claim 14, wherein the images from the first and second imaging device are taken at substantially the same instant in time and are taken with a central point in each image being offset from each other on the celestial body's surface, with one image having a relatively narrow field of view and relatively higher ground resolution and the other image having a relatively wider field of view and relatively lower ground resolution.

16. An optical system as defined in claim 10, wherein the values of Q₁ and Q₂ are different by a factor of approximately two.

17. An optical system as defined in claim 10, wherein the values of Q₁ and Q₂ are different by a factor in the range from 1.4 to 2.

18. An optical system for use in an object above a celestial body in combination with an imaging device also in the object, the system and the device being used to obtain images of portions of the surface of the celestial body, the system comprising:
an optical telescope that receives light from the outer surface of the celestial body and forms a focused image at an image plane;
a first optical path that includes at least a relay mirror and an image sensor, the relay mirror being located on an opposite side of the image plane from the optical telescope to receive light diverging from the focused image at the image plane; and
a second optical path that includes at least a relay mirror and an image sensor, the relay mirror being located on an opposite side of the image plane from the optical telescope to receive light diverging from the focused image at the image plane, the second optical path being different from the first optical path, and the second optical path producing an image of the outer surface of the celestial body that has a relatively narrower field of view than the first optical path and a relatively higher ground resolution than the first optical path;
wherein the relay mirror of the first optical path and the relay mirror of the second optical path are positioned so as to receive light from two different portions of the focused image.

19. An optical system as defined in claim 18, wherein the optical telescope is a reflecting telescope.

20. An optical system as defined in claim 19, wherein the reflecting telescope is a Cassegrain telescope having a primary mirror and a secondary mirror, the primary mirror having an opening defined at a center thereof.

21. An optical system as defined in claim 20, wherein the image plane is located on an opposite side of the opening from the secondary mirror.

22. An optical system as defined in claim 18, wherein the optical paths have Q values that are different by a factor of approximately two.

23. An optical system as defined in claim 18, wherein the optical paths have Q values that are different by a factor in the range from 1.4 to 2.
